(19) United States
(12) Patent Application Publication
(10) Pub. No.: US 2026/0178854 A1
(43) Pub. Date: Jun. 25, 2026

(54) DYNAMIC LANGUAGE SYSTEM FOR GOLF COURSES

(71) Applicant: Textron Inc., Providence, RI (US)

(72) Inventors: Cole Elliott O'Brien, North Augusta, SC (US); Preston Sering Easley, Martinez, GA (US)

(73) Assignee: Textron Inc., Providence, RI (US)

(21) Appl. No.: 19/000,959

(22) Filed: Dec. 24, 2024

(51) Int. Cl. G06F 40/58; B60K 35/22; B60K 35/26; G06F 3/04842

(52) U.S. Cl. CPC G06F 40/58; B60K 35/22; B60K 35/26; G06F 3/04842

(57) ABSTRACT

A golf system includes one or more processing circuits configured to identify a first language for alerts provided at a golf vehicle, generate an alert for a user of the golf vehicle in a second language different from the first language, translate the alert from the second language to the first language, and provide the alert in the first language to the user of the golf vehicle using at least one of a display device or a speaker of the golf vehicle.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Geofences may be established around areas of the golf course where the golf carts and other vehicles typically drive or should not drive. Areas where the golf cart or the other vehicles typically drive may include cart paths, fairways, parking lots, among others. Areas where golf cart or the other vehicles should not drive may include greens, tee boxes, buildings, water, woods, among others. When the golf cart or the other vehicles drive in the area defined by the geofence, the golf cart or the other vehicles may receive a message and/or the operation of the golf cart or the other vehicles may be limited.

### SUMMARY

One embodiment relates to a golf system. The golf system includes one or more processing circuits configured to identify a first language for alerts provided at a golf vehicle, generate an alert for a user of the golf vehicle in a second language different from the first language, translate the alert from the second language to the first language, and provide the alert in the first language to the user of the golf vehicle using at least one of a display device or a speaker of the golf vehicle.

Another embodiment relates to a golf system. The golf system includes a golf vehicle including an operator interface and a first processing circuit, and a computing system remote from the golf vehicle. The computing system includes a second processing circuit. The second processing circuit is configured to monitor a location of the golf vehicle. The second processing circuit is configured to generate an alert in a course-selected language based on the location of the golf vehicle indicating the golf vehicle is within a geofence associated with the alert. The second processing circuit is configured to transmit the alert to the golf vehicle. At least one of the first processing circuit or the second processing circuit is configured to translate the alert from the course-selected language to a user-selected language associated with the golf vehicle. The first processing circuit is configured to control the operator interface to provide the alert to a user of the golf vehicle in the user-selected language.

Still another embodiment relates to a golf system. The golf system including one or more processing circuits configured to receive a first input identifying a first language for alerts provided at a golf vehicle, receive a second input identifying a second language different from the first language for alerts provided at an external device remote from the golf vehicle, generate an alert associated with a unique identification, transmit a signal including the unique identification and provide (i) the alert in the first language to a user of the golf vehicle using at least one of a display device or a speaker of the golf vehicle or (ii) the alert in the second language to a user of the external device using at least one of a display device or a speaker of the external device in response to receiving the signal. The unique identification corresponds with the alert in the first language and in the second language such that the alert is provided in an identified language without actively translating the alert between the first language and the second language.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a top view of a golf course including the vehicle of FIG. 1, according to an exemplary embodiment.

FIG. 6 is a top view of a golf course including the vehicle of FIG. 1, according to an exemplary embodiment.

FIG. 7 is a schematic block diagram of a language system, according to an exemplary embodiment.

FIG. 8 is a graphical user interface including a profile menu and a language menu, according to an exemplary embodiment.

FIG. 9 is the graphical user interface of FIG. 8 including a message alert, according to an exemplary embodiment.

FIG. 10 is the graphical user interface of FIG. 8 including an audio alert, according to an exemplary embodiment.

FIG. 11 is the graphical user interface of FIG. 8 including a video alert, according to an exemplary embodiment.

FIG. 12 is the graphical user interface of FIG. 8 including a vehicle message panel, according to an exemplary embodiment.

FIG. 13 is the graphical user interface of FIG. 8 including a button panel, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

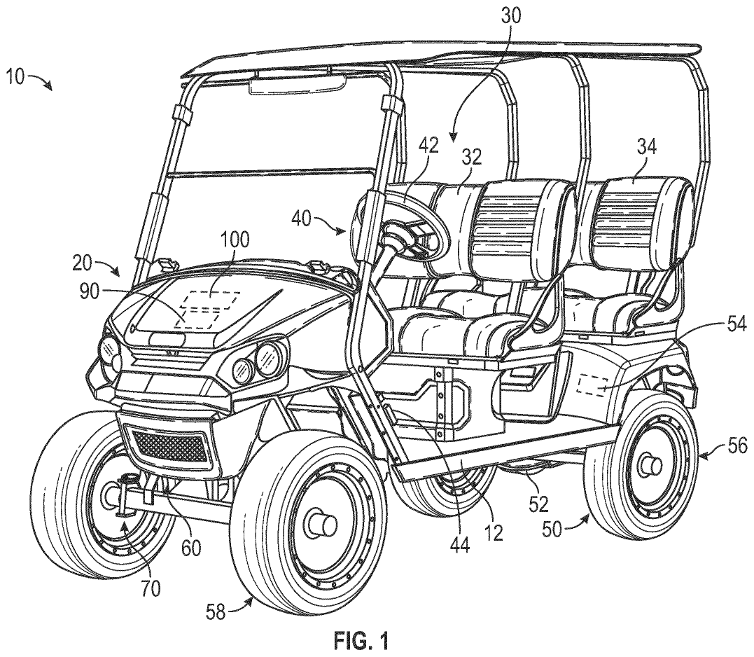

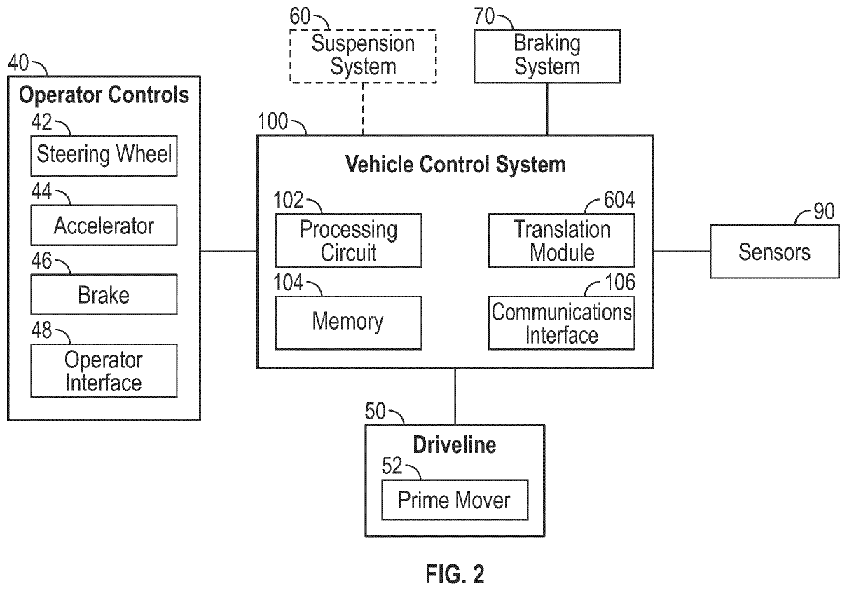

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, a ground support equipment (“GSE”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, another type of chore product that may be used on a golf course, a ground support equipment (“GSE”) that may be used at an airport, and/or still other off-road machines or vehicles.

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

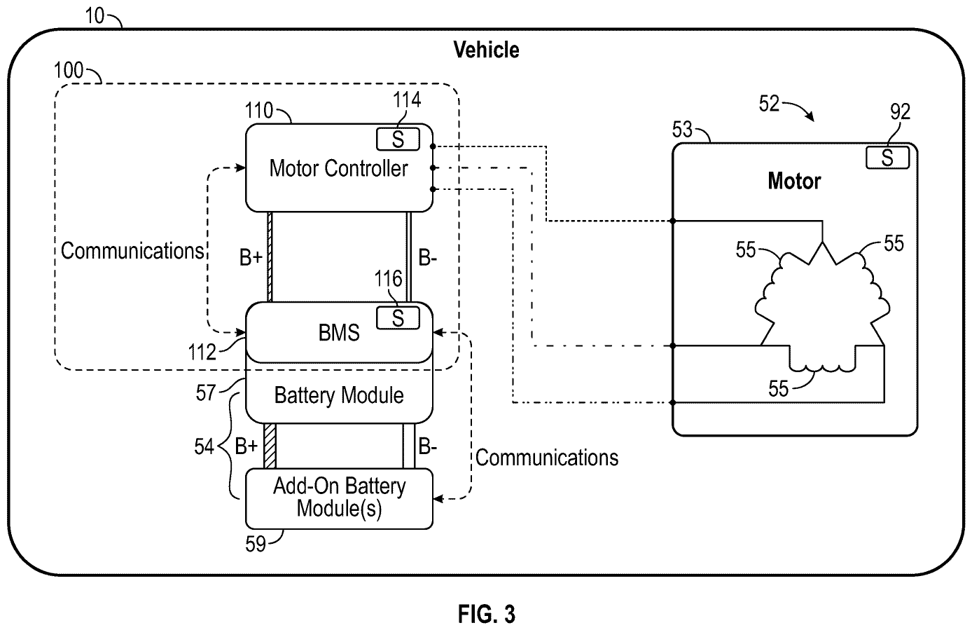

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

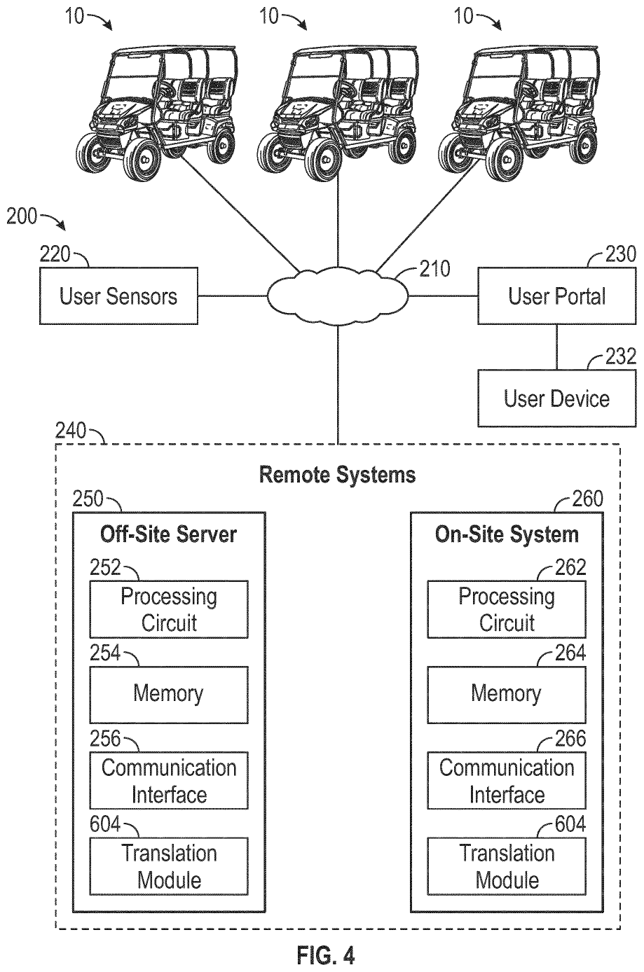

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Dynamic Language System

According to an exemplary embodiment, the fleet monitoring and control system 200, including the vehicle control system 100, the user sensors 220, the user portal 230, and the remote systems 240, is configured to facilitate improving or enhancing location detection of the vehicles 10 and associated control thereof based on location. Further, it should be understood that any of the functions or processes described herein with respect to the fleet monitoring and control system 200 may be performed by the vehicle control system 100 and/or the remote systems 240. By way of example, data collection may be performed by the vehicle control system 100 and data analytics may be performed by the vehicle control system 100. By way of another example, data collection may be performed by the vehicle control system 100 and data analytics may be performed by the remote systems 240. By way of yet another example, data collection may be performed by the vehicle control system 100, a first portion of data analytics may be performed by the vehicle control system 100, and a second portion of data analytics may be performed by the remote systems 240. By way of still another example, a first portion of data collection may be performed by the vehicle control system 100, a second portion of data collection may be performed by the remote systems 240, and data analytics may be performed by the vehicle control system 100 and/or the remote systems 240.

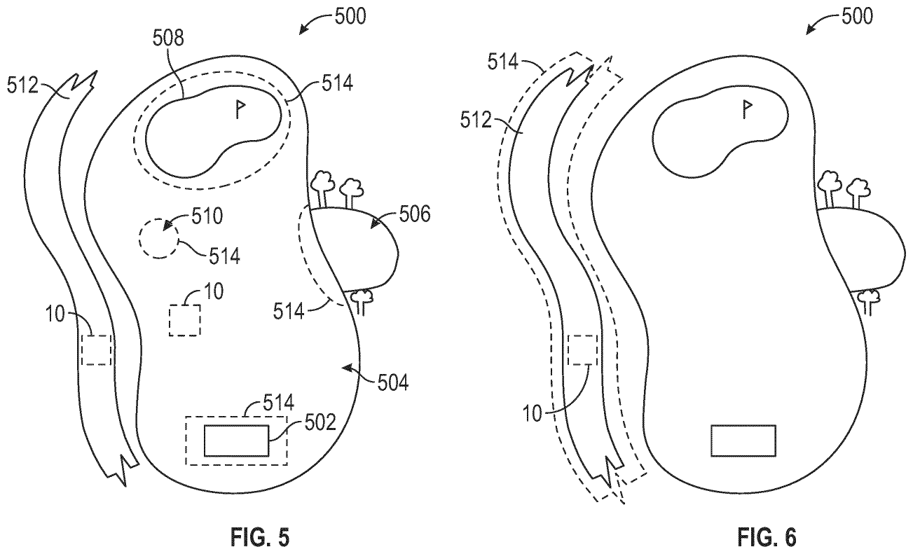

As shown in FIGS. 5 and 6, the vehicle 10 may be a golf cart driven by an operator playing golf on a golf course 500. In some embodiments, the vehicle 10 is a drink cart, a cart driven by an employee of the golf course 500 monitoring the pace of play of golfers, a cart driven by the maintenance crew working at the golf course 500, or another type of vehicle or vehicle commonly found at golf courses (e.g., a turf mower, a sprayer, an aerator, a bunker rake, etc.). A hole of the golf course 500 is shown including a tee box 502; a fairway 504; a water hazard, woods, fescue, etc., shown as out-of-bounds area 506; a putting green, shown as green 508; an area in the fairway 504 that is under repair, a non-playable area, etc., shown as hazard 510; and a path, a trail, a cart route, etc., shown as cart path 512.

The golf course 500 includes areas that should not be driven on, in, or around by the vehicle 10. By way of example, these areas may include the tee box 502, the out-of-bounds area 506, the fairway 504 during certain conditions (e.g., rain, flooding, under repair, etc.), the green 508, the hazard 510, private property along the golf course 500, a club house of the golf course 500, roped-off areas, dry/brown grass areas, areas with new sod, and/or another areas of the golf course 500. Driving on, in, or around these areas by the vehicle 10 may damage the golf course 500, be dangerous for an operator of the vehicle 10, damage the vehicle 10, be illegal (e.g., trespassing on private property), etc. Collectively, these areas are hereinafter referred to as restricted areas. Accordingly, one or more geofences (e.g., a virtual boundary, a virtual fence, etc.), shown as geofences 514, may be established around the restricted areas. The geofences 514 may be areas or boundaries defined around the restricted areas to control and manage the operation of the vehicle 10 on the golf course 500. By way of example, when the vehicle 10 is driven beyond the virtual boundary of the geofence 514 (i.e., driven into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). Areas of the golf course 500, such as the cart path 512, a parking lot of the golf course 500, the fairway 504, a cart return area, etc. that are not restricted areas defined by a geofence 514 may be drivable (e.g., navigable, permitted, unrestricted operation, etc.) by the vehicle 10, and are hereinafter referred to as the drivable areas. In some embodiments, a cart path only rule may be implemented where the vehicle 10 is supposed to drive on the cart path 512 only (e.g., after or during heavy rainfall). In such an embodiment, the geofence 514 may be established everywhere except for the cart path 512.

As shown in FIG. 6, the geofence 514 is established around the cart path 512. The geofence 514 formed around the cart path 512 may facilitate implementing the cart path only rule where the vehicle 10 is supposed to drive on the cart path 512 only (e.g., after or during heavy rainfall, to avoid ground under repair, when the cart path 512 is a bridge crossing a river/pond, etc.). As shown in FIG. 6, rather than defining geofences 514 around the restricted areas (i.e., everywhere but the cart path 512), a geofence 514 (e.g., a cart path geofence) is formed around the cart path 512. By way of example, when the vehicle 10 is driven beyond the virtual boundary of the geofence 514 (i.e., driven off of the cart path 512 and into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). In some embodiments, the geofences 514 are established around the restricted areas (as shown in FIG. 5) and around the drivable areas (e.g., around the cart path 512 as shown in FIG. 6).

According to an exemplary embodiment, a location of the vehicle 10 is monitored by the fleet monitoring and control system 200 to determine the location of the vehicle 10 relative to the geofence 514, the restricted areas, and the drivable areas. The location of the vehicle 10 may be determined based on GPS data (e.g., collected by the sensors 92 and/or the user sensors 220). The fleet monitoring and control system 200 may be configured to store the location data and analyze the location data to make operational decisions based thereon.

In some embodiments, a true location (e.g., real-time position, actual location, etc.) of the vehicle 10 is different than a tracked location of the vehicle 10 determined based on the GPS data. The error or difference between the tracked location of the vehicle 10 and the true location of the vehicle 10 may be caused by signal interference (e.g., geomagnetic radiation), solar storms, signal obstruction (e.g., tree cover, building cover, etc.), weather (e.g., rain, snow, pressure, etc.), control system quality, malfunctioning sensors, and/or any other combination of internal hardware or external factors. The difference between the tracked location and the true location may be referred to herein as location or GPS drift. Because of the difference between the tracked location and the true location, the fleet monitoring and control system 200 may determine, based on the GPS position, that the vehicle 10 is operating in the restricted area (e.g., near/on a green or tee box, near/on a hazard such as ground under repair, an area defined by a geofence, a non-drivable area, etc.) when in reality, the true location of the vehicle 10 is not in the restricted area. In such an example, the fleet monitoring and control system 200 may undesirably limit the operation of the vehicle 10. Similarly, because of the difference between the tracked location and the true location, the fleet monitoring and control system 200 may determine, based on the GPS position, that the vehicle 10 is not operating in the restricted area (e.g., operating in the drivable area) when in reality, the true location of the vehicle 10 is in the restricted area. In such an example, the fleet monitoring and control system 200 may undesirably permit operation of the vehicle 10 within the restricted area.

According to an exemplary embodiment, the fleet monitoring and control system 200 is configured to correct (e.g., adjust for, account for, etc.) the undesirable controlling of the operation of the vehicles 10 as a result of the GPS drift. By way of example, the fleet monitoring and control system 200 may be configured to force the tracked location to be within the drivable area in response to a determination, based on the true location, that the vehicle 10 is traveling in the drivable area and the tracked location indicates that the vehicle 10 is in the restricted area. By way of another example, the fleet monitoring and control system 200 maybe configured to force the tracked location to be within the restricted area in response to a determination, based on the true location, that the vehicle 10 is traveling in the restricted area and the tracked location indicates that the vehicle 10 is in the drivable area. By way of another example, the fleet monitoring and control system 200 may be configured to control operation of the vehicle 10 based on a corrective position determined using RTK information. In such an example, the corrective position may be based on corrective position data determined based on (i) communications between the on-site system 260 and a satellite (e.g., a global navigation satellite system (GNSS) satellite) and (ii) a known, fixed location of the on-site system 260. By way of yet another example, the fleet monitoring and control system 200 may be configured to control operation of the vehicle 10 based on the type of surface the vehicle 10 is driving on. In some embodiments, when a determination is made that the true location is different than the tracked location (e.g., the coordinates are different), the fleet monitoring and control system 200 may be configured to recalibrate (e.g., reset) the sensors 90 collecting the GPS data and/or send a signal commanding the user sensors 220 to recalibrate.

The fleet monitoring and control system 200 may control an operation of the operator controls 40, the driveline 50, the suspension system 60, the braking system 70, and/or any other component of the vehicle 10 based on the true location (e.g., a corrected position, an actual location, etc.) of the vehicle 10 relative to the restricted areas and the drivable areas. By way of example, the fleet monitoring and control system 200 may determine, based on the true location, that the vehicle 10 is operating (e.g., driving forward, driving backward, idling, stopped, parked, etc.) (i) in a drivable area defined by a respective geofence 514, (ii) near a respective geofence 514 (e.g., within 5 yards of the respective geofence 514, within 10 yards of the respective geofence 514, etc.), or (iii) in a restricted area defined by a respective geofence 514.

In response to a determination that the vehicle 10 is operating in a drivable area, the fleet monitoring and control system 200 may facilitate (e.g., permit operation of the vehicle 10 in a first mode of operation) normal or unrestricted operation of the operator controls 40, the driveline 50, the suspension system 60, the braking system 70, and/or any other component of the vehicle 10. By way of example, in response to a determination that the vehicle 10 is operating in a drivable area and outside of a restricted area defined by the geofence 514, the fleet monitoring and control system 200 may permit operation of the vehicle 10 in the first mode of operation. By way of another example, in response to a determination that the vehicle 10 is operating in a drivable area defined by the geofence 514 (e.g., operating on the cart path 512 within the cart path geofence, operating on the fairway 504 within a fairway geofence, etc.) the fleet monitoring and control system 200 may permit operation of the vehicle 10 in the first mode of operation.

In response to a determination that the vehicle 10 is operating in or near a restricted area (e.g., near or in the geofence 514), the fleet monitoring and control system 200 may limit operation (e.g., limit operation of the vehicle 10 in a second mode of operation) of the operator controls 40, the driveline 50, the suspension system 60, the braking system 70, and/or any other component of the vehicle 10. By way of example, the fleet monitoring and control system 200 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In such an example, to transition the vehicle 10 to the second mode of operation, the fleet monitoring and control system 200 may (i) shift the vehicle 10 into neutral (e.g., such that no power is transmitted to the prime mover 52) and/or (ii) operate the braking system 70 to slow the vehicle 10 to a stop. The vehicle 10 may be limited to the second mode of operation until the vehicle 10 navigates (e.g., is navigated by an operator) to the drivable area.

According to an exemplary embodiment, the fleet monitoring and control system 200 is configured to provide an alert (e.g., visually via a display of the operator interface 48, audibly via a speaker of the operator interface 48, in a tactile manner by shaking the steering wheel 42, etc.) to the operator of the vehicle 10. In some embodiments, the alert is indicative of a location of the geofence 514. By way of example, in response to a determination that the vehicle 10 is operating in or near a restricted area (e.g., near or in the geofence 514, near or in a keep-out geofence, etc.), the fleet monitoring and control system 200 may provide an alert indicative of the location of the restricted area (e.g., a boundary of the geofence 514). By way of another example, in response to a determination that the vehicle 10 is operating in or near a drivable area (e.g., near or in the geofence 514, near or in a keep-in geofence, near or in a cart path only geofence, etc.), the fleet monitoring and control system 200 may provide an alert indicative of the location of the drivable area (e.g., a boundary of the geofence 514). In some embodiments, the alert is indicative of a message (e.g., a text alert, a video alert, an audio alert, etc.). By way of example, in response to a determination that the location of the vehicle 10 indicates that the vehicle 10 is in an area (e.g., a drivable area) defined by the geofence 514 (e.g., a message geofence), the fleet monitoring and control system 200 may provide an alert indicative of the message. In some embodiments, the message includes messages from the clubhouse, course instructions and rules (e.g., 90-degree rules, cart path only rules, etc.), hole-specific information (e.g., hole number, yardage, handicap, etc.), pace of play messages (e.g., to speed up the pace of play), safety warnings, end of round messages, among others. In some embodiments, the alert is indicative of an advertisement (e.g., a picture, a video, an audio file, etc.). By way of example, in response to a determination that the location of the vehicle 10 indicates that the vehicle 10 is in an area (e.g., a drivable area) defined by the geofence 514 (e.g., an advertisement geofence), the fleet monitoring and control system 200 may provide an alert indicative of the advertisement. In some embodiments, the advertisement includes advertisements from businesses, course specific promotions (e.g., food and drink specials, equipment and apparel sales, etc.), course specific events (e.g., golf lessons, upcoming outings, etc.), among others.

In some embodiments, the fleet monitoring and control system 200 is configured to provide the alert in response to a determination that the vehicle 10 has driven beyond the virtual boundary of the geofence 514 (e.g., driven off of a first area defined by the geofence 514 and into a second area not defined by the geofence 514). By way of example, in response to a determination that the vehicle 10 left a restricted area defined by the geofence 514 (e.g., indicative that the vehicle 10 has driven off of the restricted area and into a drivable area), the fleet monitoring and control system 200 may provide the alert.

In some embodiments, the fleet monitoring and control system 200 is configured to provide the alert to the operator of the vehicle 10 in response to an input received from the user device 232. By way of example, the fleet monitoring and control system 200 may provide the alert in response to a user input (e.g., manual indication) to the user device 232 to provide the alert. In such an example, the user input may include a typed message, an audio recording, a selection of a button, etc., to the user device 232 to provide the alert.

As shown in FIGS. 2, 4, and 7, a dynamic language system (e.g., alert translation system, language translation system, etc.), shown as language system 600, includes a language translation module, shown as translation module 604, configured to translate alerts (e.g., the alerts, messages, and advertisements as discussed in greater detail above) from a second language (e.g., English, Spanish, Japanese, Korean, etc.) to a first language different from the second language (or from the first language to the second language). As shown in FIGS. 2 and 4, the translation module 604 is included in the vehicle control system 100, the off-site server 250, and the on-site system 260 such that translating the alert can be performed on the vehicle 10 by the vehicle control system 100, and remote from the vehicle 10 by the remote systems 240 (e.g., the off-site server 250 and the on-site system 260). In some embodiments, the translation module 604 is included in at least one of the vehicle control system 100, the off-site server 250, or the on-site system 260.

It should be understood that any of the functions or processes described herein with respect to the language system 600 may be performed by the vehicle control system 100 and/or the remote systems 240. By way of example, translation operations may be performed by the vehicle control system 100. By way of another example, translation operations may be performed by the off-site server 250. By way of yet another example, translation operations may be performed by the on-site system 260. By way of yet another example, a first portion of translation operations may be performed by the vehicle control system 100, and a second portion of translation operations may be performed by the remote systems 240 (e.g., the off-site server 250 and/or the on-site system 260). By way of yet another example, a first portion of translation operations may be performed by the off-site server 250, and a second portion of translation operations may be performed by the on-site system 260. By way of yet another example, a first portion of translation operations may be performed by the vehicle control system 100 of a first vehicle 10, and a second portion of translation operations may be performed by the vehicle control system 100 of a second vehicle 10. In examples where the vehicle control system 100 performs at least a portion of the translation operations, the translation module 604 may download and store language models, dictionaries, translation rules, etc., such that the translation operations are performed locally on the vehicle 10. In such examples, the translation module 604 facilitates offline translation operations (e.g., without a network connection). In examples where the remote systems 240 perform at least a portion of the translation operations, the translation module 604 may be or may include a cloud service that hosts language models, dictionaries, translation rules, etc., to translate the alerts.

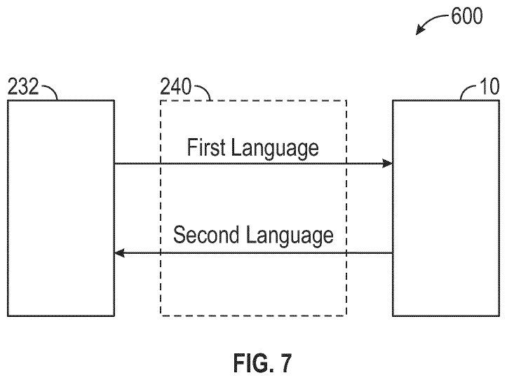

As shown in FIG. 7, a signal (e.g., a first arrow extending from the user device 232 to the vehicle 10) is sent from the user device 232 to the vehicle 10. The signal is indicative of a first alert (e.g., a first message, a first advertisement, etc.) in the second language. By way of example, the first alert may include a message typed in the second language, an audio recording in the second language, a video with audio in the second language, a video with captions in the second language, an advertisement in the second language, among other alerts in the second language. As shown in FIG. 7, the first alert provided from the user device 232 to the vehicle 10 is generated at the user device 232. By way of example, the first alert may be generated based on an input (e.g., by a user) to the user device 232.

According to an exemplary embodiment, the first alert generated at the user device 232 (e.g., an external device remote from the vehicle 10) is translated from the second language to the first language different than the second language. In some embodiments, the first alert is translated by the translation module 604 located at the remote systems 240. In such embodiments, the translation module 604 is or includes a cloud-based service configured to receive the signal associated with the first alert and translate the first alert from the second language to the first language. By way of example, the translation module 604 may be located at the off-site server 250 and/or the on-site system 260 such that the first alert is translated by the off-site server 250 and/or the on-site system 260, respectively. In other embodiments, the first alert is translated by the translation module 604 located at the vehicle 10. By way of example, the translation module 604 may be located on the vehicle 10 such that the first alert is translated by the vehicle control system 100.

According to an exemplary embodiment, after being translated (e.g., by the remote systems 240 and/or the vehicle control system 100), the first alert is provided in the first language to the vehicle 10 (e.g., to a user of the vehicle 10). In some embodiments, the first alert is provided to the vehicle 10 for display on a graphical user interface (“GUI”) (e.g., vehicle GUI 610) displayed on a display of the operator interface 48, and/or provided to the vehicle 10 to be audibly played by a speaker of the operator interface 48. In some embodiments, the first alert is to the vehicle 10 in response to a determination that the location of the vehicle 10 indicates that the vehicle 10 is in an area defined by a message geofence (e.g., a respective geofence 514).

As shown in FIG. 7, a signal (e.g., a second arrow extending from the vehicle 10 to the user device 232) is sent from the vehicle 10 to the user device 232. The signal is indicative of a second alert (e.g., a second message, a second advertisement, etc.) in the first language. By way of example, the second alert may include a message typed in the first language, an audio recording in the first language, a video with audio in the first language, a video with captions in the first language, an advertisement in the first language, among other alerts in the first language. As shown in FIG. 7, the second alert provided from the vehicle 10 to the user device 232 is generated at the vehicle 10. By way of example, the second alert may be generated based on an input (e.g., by a user) to the operator interface 48 of the vehicle 10.

According to an exemplary embodiment, the second alert generated at the vehicle 10 is translated from the first language to the second language. In some embodiments, the second alert is translated by the translation module 604 located at the remote systems 240. In such embodiments, the translation module 604 is or includes a cloud-based service configured to receive the signal associated with the second alert and translate the second alert from the first language to the second language. By way of example, the translation module 604 may be located at the off-site server 250 and/or the on-site system 260 such that the second alert is translated by the off-site server 250 and/or the on-site system 260, respectively. In other embodiments, the second alert is translated by the translation module 604 located at the vehicle 10. By way of example, the translation module 604 may be located on the vehicle 10 such that the second alert is translated by the vehicle control system 100.

According to an exemplary embodiment, after being translated (e.g., by the remote systems 240 and/or the vehicle control system 100), the second alert is provided in the second language to the user device 232. In some embodiments, the second alert is provided to the user device 232 for display on a graphical user interface displayed on a display of the user device 232, and/or provided to the user device 232 to be audibly played by a speaker thereof.

In some embodiments, an alert in the second language is generated at a first vehicle 10, translated by the translation module 604 from the second language to the first language, and provided from the first vehicle 10 to a second vehicle 10 in the first language. Similarly, in some embodiments, an alert in the first language is generated at the vehicle 10, translated by the translation module 604 from the first language to the second language, and provided from the second vehicle 10 to the first vehicle 10 in the second language. By way of example, the alert may be generated based on an input (e.g., by a user) to the operator interface 48 of the first vehicle 10 and/or the second vehicle 10. In some embodiments, the alert is translated (e.g., from the second language to the first language or from the first language to the second language) by the translation module 604 located at the remote systems 240. In other embodiments, the alert is translated by the translation module 604 located at the first vehicle 10 and/or the second vehicle 10.

According to an exemplary embodiment, the vehicle 10 and/or the user device 232 receiving the alert (e.g., the translated alert) are configured to receive an input identifying the language for the alert provided at the vehicle 10 and/or user device 232, respectively. By way of example, the operator interface 48 may be configured to receive an input identifying the first language and provide the input to the translation module 604. In such an example, the translation module 604 is configured to translate the alert generated at the user device 232 from the second language (e.g., the language in which the alert was generated) to the first language (e.g., the identified language for the alert provided at the vehicle 10). By way of another example, the user device 232 may be configured to receive an input identifying the second language and provide the input to the translation module 604. In such an example, the translation module 604 is configured to translate the alert generated at the vehicle 10 from the first language (e.g., the language in which the alert was generated) to the second language (e.g., the identified language for the alert provided at the user device 232).

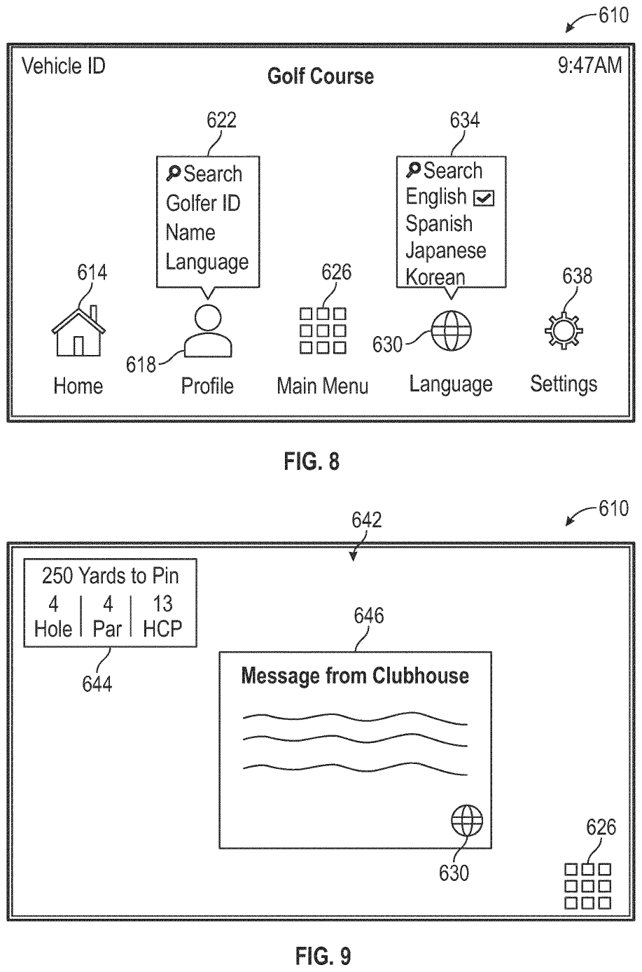

As shown in FIGS. 8-13, a graphical user interface, shown as vehicle GUI 610, is configured to provide one or more views, menus, buttons, etc., to facilitate providing alerts and generating alerts at the vehicle 10. The vehicle GUI 610 is configured to be provided to the operator interface 48 for display on the one or more displays thereof. The operator interface 48 is configured to receive an input from the user to provide the user with the ability to control one or more functions of and/or provide commands to the vehicle GUI 610 and the language system 600. By way of example, the user may interact with (e.g., engage with, provide an input to, etc.) the vehicle GUI 610 via the operator interface 48 to cause the vehicle GUI 610 to display one or more additional elements, menus, panels, etc.

As shown in FIG. 8, the vehicle GUI 610 includes a first element, shown as home element 614, configured to provide the user with the ability to return the vehicle GUI 610 to a home view (e.g., the view shown in FIG. 8); a second element, shown as profile button 618, configured to provide the user with the ability to link a profile associated with the user with the vehicle 10 being operated by the user; a third element, shown as main menu button 626, configured to provide the user with the ability to have the vehicle GUI 610 display one or more elements (e.g., the home element 614, the profile button 618, the language button 630, the settings button 638, etc.); a fourth element, shown as language button 630, configured to provide the user with the ability to identify a language; and a fifth element, shown as settings button 638, configured to provide the user with the ability to configure one or more settings of the vehicle GUI 610 (e.g., display settings, developer settings, etc.). In some embodiments, the vehicle GUI 610 includes more or fewer elements than shown in FIG. 8. As shown in FIGS. 8-13, the main menu button 626 and the language button 630 are provided on the vehicle GUI 610 regardless of the view, information, menus, etc., displayed thereon.

As shown in FIG. 8, the profile button 618 includes a profile identification menu, shown as profile menu 622. In some embodiments, the profile menu 622 is always displayed on the vehicle GUI 610 when the profile button 618 is displayed on the vehicle GUI 610. In other embodiments, the profile menu 622 is displayed (e.g., as a pop-up menu) in response to a selection of the profile button 618. As shown in FIG. 8, the profile menu 622 includes a search feature configured to provide the user with the ability to search for a user profile (e.g., a profile associated with the user) and select the user profile to link the user profile with the vehicle 10 being operated by the user. The profile menu 622 is configured to provide information relating to the user profile for display on the vehicle GUI 610. By way of example, the profile menu 622 may display a golfer ID (e.g., a unique identifier associated with the user profile), a name (e.g., a name of the user associated with the user profile), a language (e.g., a language associated with the user profile, a language identified by the user during the creation of the user profile, a language identified using the language button 630 while the user profile is linked with the vehicle 10, the first language, etc.), among other information.

In some embodiments, the translation capabilities of the translation module 604 on the vehicle 10 are pre-downloaded and stored on the vehicle control system 100 based on the user profile associated with the vehicle 10. In such embodiments, the vehicle control system 100 does not need to store all language translation capabilities at once, but only the specific first language and second language. In some embodiments, the user profile of the golfer is associated with the vehicle 10 remote from the vehicle 10 (e.g., via the user device 232, the remote systems 240, etc.). By way of example, the clubhouse may pre-assign the vehicle 10 to a golfer based on a tee sheet and the translation capabilities for the language identified in the user profile may be pre-emptively loaded onto the translations module 604 of the vehicle control system 100 prior to the golfer accessing the vehicle 10.

As shown in FIG. 8, the language button 630 includes a language selection menu, shown as language menu 634. In some embodiments, the language menu 634 is always displayed on the vehicle GUI 610 when the language button 630 is displayed on the vehicle GUI 610. In other embodiments, the language menu 634 is displayed (e.g., as a pop-up menu) in response to a selection of the language button 630. As shown in FIG. 8, the language menu 634 includes a search feature configured to provide the user with the ability to search for a language and identify (e.g., select) a language. In some embodiments, the language menu 634 displays commonly spoken languages. Using the language button 630 and the language menu 634, the user may identify a language that they wish the vehicle GUI 610 to be provided in (e.g., a language they wish text to be displayed in, a language they wish audio to be played in, etc.). As shown in FIG. 8, the language menu 634 provides an indication (e.g., a check mark, a highlight, etc.) of the identified language.

According to an exemplary embodiment, the vehicle GUI 610 is configured to display text such as text identifying the home element 614, the profile button 618, the main menu button 626, the language button 630, and the settings button 638; text displayed by the profile menu 622 and the language menu 634; and any other text displayed by the vehicle GUI 610 in the identified language. By way of example, when the identified language is English, all text displayed on the vehicle GUI 610 may be displayed in English. In some embodiments, the translation module 604 includes a database of stored templates of the vehicle GUI 610 in different languages such that in response to an input of the identified language, the translation module 604 provides the template of the vehicle GUI 610 in the identified language for display on the operator interface 48.

As shown in FIGS. 9-13, the vehicle GUI 610 includes a hole view panel, shown as golf course view panel 642, including a hole information panel, shown as hole information 644. The hole information 644 includes information regarding the hole at which the vehicle 10 is located such as yardage information (e.g., yardage from the tee to the pin, yardage from the vehicle 10 to the pin, etc.), the hole number (e.g., hole 4), par information (e.g., par 3, par 4, par 5, etc.), handicap information (e.g., 13 handicap (“HCP”), indicating a difficulty of the hole, etc.), among other information. In some embodiments, the golf course view panel 642 is configured to display (i) the tee box 502, the fairway 504, the out-of-bounds area 506, the green 508, the hazard 510, etc. of one or more holes, (ii) the cart path 512, and (ii) any other features of the golf course 500. The user may interact with the golf course view panel 642 to zoom in to view a particular area of the golf course 500, zoom out to view a larger area of the golf course 500, pan across the map to view different areas of the golf course 500, rotate the map, and/or otherwise interact with the golf course view panel 642 to manipulate a view of the golf course 500 displayed by the golf course view panel 642. In some embodiments, the user provides an input to the golf course view panel 642 specifying a respective hole of the golf course 500, and the golf course view panel 608 is configured to display the respective hole. In some embodiments, the golf course view panel 642 is configured to display real-time updates regarding the locations of the vehicles 10 on the golf course 500. As shown in FIGS. 9-13, the golf course view panel 642 includes the main menu button 626 and the language button 630.

As shown in FIGS. 9-11, the vehicle GUI 610 is configured to display (or display an indication of) and/or the speaker of the operator interface 48 is configured to audibly play (i) a first alert (e.g., text message, text alert, advertisement message, etc.), shown as message alert 646, (ii) a second alert (e.g., audio recording, audible advertisement alert, etc.), shown as audio alert 650, and/or (iii) a third alert (e.g., video, video advertisement, etc.), shown as video alert 658, to provide the message alert 646, the audio alert 650, and/or the video alert 658 to the operator of the vehicle 10. The vehicle GUI 610 is configured to provide the message alert 646, the audio alert 650, and the video alert 658 in the identified language (e.g., the first language). In some embodiments, as discussed in greater detail with respect to FIG. 7, the message alert 646, the audio alert 650, and/or the video alert 658 are generated at the user device 232 in the second language. In other embodiments, the message alert 646, the audio alert 650, and/or the video alert 658 are generated at a second vehicle 10 in the second language. In still other embodiments, the message alert 646, the audio alert 650, and/or the video alert 658 are generated in response to the vehicle 10 crossing into a respective geofence 514. By way of example, in response to a determination that the vehicle 10 is operating in a message geofence, the message alert 646, the audio alert 650, and/or the video alert 658 may be generated indicative of a message (e.g., from the clubhouse). By way of another example, in response to a determination that the vehicle 10 is operating in an advertisement geofence, the message alert 646, the audio alert 650, and/or the video alert 658 may be generated indicative of an advertisement (e.g., from a business, from the clubhouse, etc.). After being generated, the message alert 646, the audio alert 650, and/or the video alert 658 are translated by the translation module 604 located at the remote systems 240 and/or located at the vehicle 10 (e.g., the vehicle 10 receiving the message alert 646, the audio alert 650, and/or the video alert 658, a first vehicle 10, etc.) from the second language to the first language (e.g., the identified language), and are provided to the operator interface 48 in the first language.

As shown in FIG. 9, the message alert 646 includes text displayed in the first language. In some embodiments, the message alert 646 additionally includes text displayed in the second language (e.g., the original untranslated text generated at the user device 232, for example). As shown in FIG. 9, the vehicle GUI 610 includes the language button 630 configured to provide the user with the ability to change the identified language, thereby changing the language of the message alert 646 provided for display on the vehicle GUI 610. By way of example, the user may select the language button 630 and identify the second language, a third language, a fourth language, etc., to have the message alert 646 be translated to and displayed in the identified second language, a third language, a fourth language, etc. In some embodiments, the message alert 646 is generated at a second vehicle 10 and provided at a first vehicle 10.

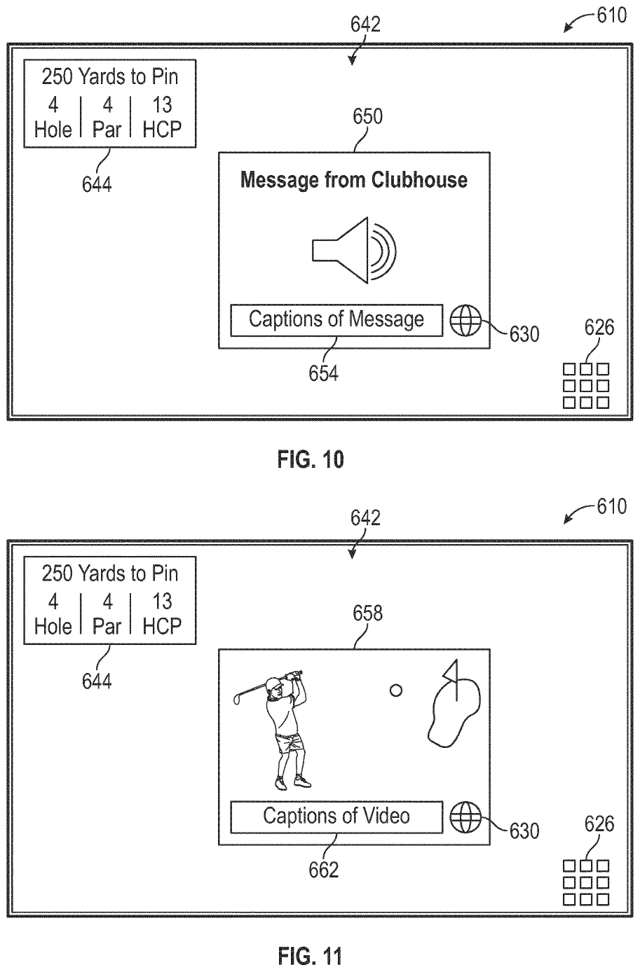

As shown in FIG. 10, the vehicle GUI 610 is configured to display an indication of the audio alert 650 being provided. In response to the audio alert 650 being provided to the vehicle 10, the audio alert 650 is provided to the operator of the vehicle 10 using a speaker of the operator interface 48. By way of example, the speaker may be configured to audibly play the audio alert 650. In some embodiments, the audio alert 650 is generated at the user device 232 in response to the user providing an audio input (e.g., a voice recording) to the user device 232. In such embodiments, the translation module 604 translates the audio input from the second language to the first language, and the audio input is played in the first language (e.g., played in a robotic voice) using the speaker. In other embodiments, the user may provide a text input (e.g., a typed input) to the user device 232. In such embodiments, the translation module 604 translates the text input from the second language to the first language, and a text-to-speech module (located at the remote systems 240 and/or the vehicle 10) generates (e.g., from the text input in the first language) the audio alert 650 in the first language. In some embodiments, the audio alert 650 is generated at a second vehicle 10 and provided at a first vehicle 10.

As shown in FIG. 10, the vehicle GUI 610 is configured to display captions, shown as audio alert captions 654, in the first language of the audio alert 650 being played. By way of example, a speech-to-text module (located at the remote systems 240 and/or the vehicle 10) may generate the audio alert captions 654 in the first language based on the audio alert 650 and provide the audio alert captions 654 to the vehicle GUI 610 for display thereon. In some embodiments, the audio alert captions 654 are displayed in the second language corresponding with the language the audio alert 650 was generated in, and the audio alert 650 is played in the first language. In other embodiments, the audio alert captions 654 are displayed in the first language, and the audio alert 650 is played in the second language. As shown in FIG. 9, the vehicle GUI 610 includes the language button 630 configured to provide the user with the ability to change the identified language, thereby changing the language of the audio alert 650 provided using the speaker of the vehicle 10 and/or the language of the audio alert captions 654 provided for display on the vehicle GUI 610. By way of example, the user may select the language button 630 and identify the second language, a third language, a fourth language, etc., to have the audio alert 650 be translated to and played in the identified second language, a third language, a fourth language, etc. In some embodiments, the audio alert 650 is automatically generated and provided to the vehicle 10 in response to the vehicle 10 entering a geofence.

As shown in FIG. 11, the video alert 658 includes one or more videos, graphic interchange format (“GIF”) files, etc. provided for display on the vehicle GUI 610. In some embodiments, the video alert 658 includes an audio file associated therewith and provided to the vehicle 10 to be played by the speaker of the operator interface 48 in coordination with the video displayed on the vehicle GUI 610. In some embodiments, the video alert 658 is generated at the user device 232 in response to the user providing a video input to the user device 232. In such embodiments, the translation module 604 translates the audio associated with the video input from the second language to the first language, and the audio is played in the first language (e.g., played in a robotic voice) using the speaker. In some embodiments, the video alert 658 is generated at a second vehicle 10 and provided at a first vehicle 10. In some embodiments, the video alert 658 is automatically generated and provided to the vehicle 10 in response to the vehicle 10 entering a geofence.

As shown in FIG. 11, the vehicle GUI 610 is configured to display captions, shown as video alert captions 662, in the first language of the video alert 658 being played. By way of example, a speech-to-text module (located at the remote systems 240 and/or the vehicle 10) may generate the video alert captions 662 in the first language based on the audio associated with the video alert 658 and provide the video alert captions 662 to the vehicle GUI 610 for display thereon. In some embodiments, the video alert captions 662 are displayed in the second language corresponding with the language the video alert 658 was generated in, and audio associated with the video alert 658 is played in the first language. In other embodiments, the video alert captions 662 are displayed in the first language, and the audio associated with the video alert 658 is played in the second language. In yet other embodiments, the video alert captions 662 are displayed in the first language, and the audio associated with the video alert 658 is not played (e.g., muted, cut, silenced, etc.). As shown in FIG. 11, the vehicle GUI 610 includes the language button 630 configured to provide the user with the ability to change the identified language, thereby changing the language of the video alert 658 provided using the speaker of the vehicle 10 and/or the language of the video alert captions 662 provided for display on the vehicle GUI 610. By way of example, the user may select the language button 630 and identify the second language, a third language, a fourth language, etc., to have the video alert 658 be translated to and played in the identified second language, a third language, a fourth language, etc.

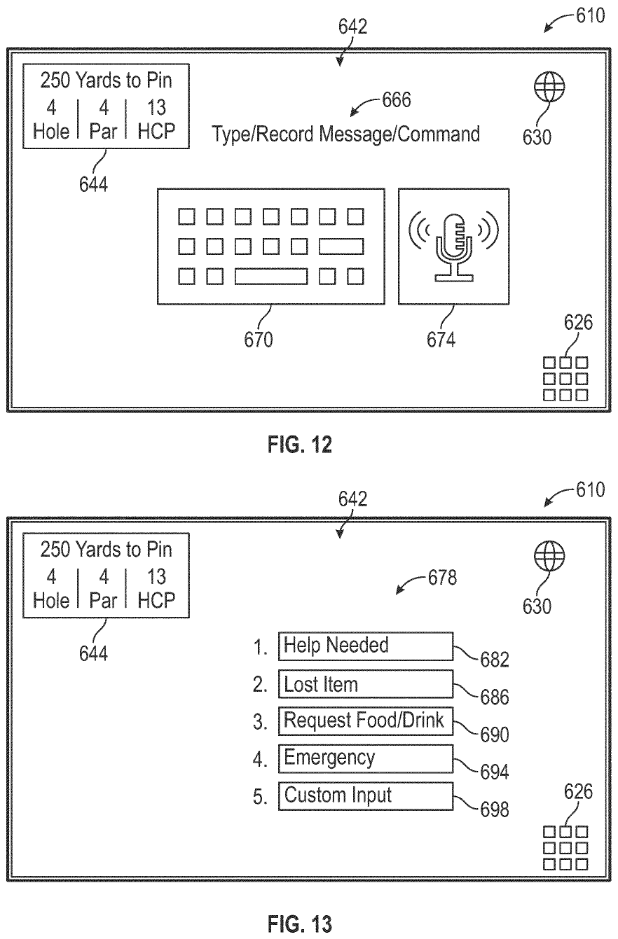

As shown in FIG. 12, the vehicle GUI 610 is configured to display a first message panel, shown as vehicle message panel 666, configured to provide the user with the ability to generate one or more alerts at the vehicle 10. As shown in FIG. 12, the vehicle message panel 666 includes a keyboard element, shown as keyboard 670, and an audio element, shown as audio button 674. The keyboard 670 is configured to provide the user with the ability to type a message (provide an input to the operator interface 48) to generate a message alert 646 at the vehicle 10. In some embodiments, the keyboard 670 includes the alphabet (e.g., letters, scripts, etc.), symbols (e.g., punctuations, diacritics, etc.), layout, etc. associated with the first language (e.g., the identified language). By way of example, if the first language is English, the keyboard 670 may include the letters of the Latin alphabet, the keyboard 670 may include symbols commonly used in English, and the keyboard 670 may define a QWERTY layout. The audio button 674 is configured to provide the user with the ability to initiate recording an audio message (e.g., a voice recording) to generate an audio alert 650 at the vehicle 10. In some embodiments, the audio alert 650 is generated at the vehicle 10 using a microphone of the sensors 90. In some embodiments, the vehicle message panel 666 includes a video element (e.g., video button) configured to provide the user with the ability to initiate recording a video message (e.g., a video recording) to generate a video alert 658 at the vehicle 10. By way of example, the video alert 658 may be generated at the vehicle 10 using a camera of the sensors 90. The message alert 646, the audio alert 650, and/or the video alert 658 generated at the vehicle 10 (e.g., the first vehicle) in the first language may be translated by the translation module 604 from the first language to the second language, and provided at the user device 232 and/or the second vehicle 10 in the second language (or to a different language identified by the user device 232 and/or the second vehicle 10).

As shown in FIG. 13, the vehicle GUI 610 is configured to display a second message panel, shown as button panel 678, configured to provide the user with the ability to generate one or more alerts at the vehicle 10. The button panel 678 includes a first element, shown as help button 682, configured to provide the user with the ability to generate an alert at the vehicle 10 indicative of a request for help; a second element, shown as lost item button 686, configured to provide the user with the ability to generate an alert at the vehicle 10 indicative of a lost item (e.g., lost club, lost personal item, etc.); a third element, shown as request button 690, configured to provide the user with the ability to generate an alert at the vehicle 10 indicative of a request for food or drinks (e.g., an order placed at a restaurant or bar at the golf course 500, a request for a drink cart to navigate to the location of the vehicle 10, etc.); a fourth element, shown as emergency button 694, configured to provide the user with the ability to generate an alert at the vehicle 10 indicative of an emergency; and a fifth element, shown as custom input button 698, configured to provide the user with the ability to generate a custom alert at the vehicle 10. In some embodiments, selecting the custom input button 698 causes the vehicle GUI 610 to display the vehicle message panel 666 to provide the user with the ability to generate a message alert 646, an audio alert 650, and/or a video alert 658. In some embodiments, the button panel 678 includes more or fewer elements than shown in FIG. 13. According to an exemplary embodiment, the help button 682, the lost item button 686, the request button 690, the emergency button 694, and the custom input button 698 include text identifying the same. In such an embodiment, the text is displayed in the first language (e.g., the identified language).

According to an exemplary embodiment, each of the help button 682, the lost item button 686, the request button 690, and the emergency button 694 is associated with a respective unique button identification corresponding to a respective alert. By way of example, the help button 682 may be associated with a first unique button identification corresponding to an alert indicative of a request for help, the lost item button 686 may be associated with a second unique button identification corresponding to an alert indicative of a lost item, the request button 690 may be associated with a third unique button identification corresponding to an alert indicative of a request for food or drinks, and the emergency button 694 may be associated with a fourth unique button identification corresponding to an alert indicative of an emergency. In response to a selection of a respective one of the help button 682, the lost item button 686, the request button 690, or the emergency button 694, the vehicle control system 100 is configured to transmit a signal indicative of the respective unique identifier associated with the selected help button 682, lost item button 686, request button 690, or emergency button 694 to the remote systems 240. The unique identifier enables the remote systems 240 to identify the alert corresponding with the unique identifier, and provide for display on the user device 232 the corresponding alert in the second language. Accordingly, the remote systems 240 may retrieve the corresponding alert directly in the second language, thereby bypassing the need for the translation module 604 to translate the corresponding alert. In other words, providing a respective unique identifier corresponding with a respective alert to the remote systems 240 (e.g., instead of providing an alert in the first language), eliminates the need for the translation module 604 to perform real-time language translation because the corresponding alert may already be stored or predefined in the second language by the remote systems 240. In some embodiments, the button panel 678 is provided for display on the user device 232 to generate an alert (e.g., by selecting the help button 682, the lost item button 686, the request button 690, and/or the emergency button 694) at the user device 232 and provide, in the first language, the alert based on the unique identifier at the vehicle 10 without the translation module 604 actively translating (e.g., providing real-time translations of) the alert.

As used herein, the first language may be referred to as a “user-selected language” or a “golfer-selected language” and the second language may be referred to as a “course-selected language” or a “employee-selected language.”

As utilized herein with respect to numerical ranges, the terms “approximately,” “about,”“substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf system comprising:
one or more processing circuits configured to:
identify a first language for alerts provided at a golf vehicle;
generate an alert for a user of the golf vehicle in a second language different from the first language;
translate the alert from the second language to the first language; and
provide the alert in the first language to the user of the golf vehicle using at least one of a display device or a speaker of the golf vehicle.

2. The golf system of claim 1, wherein the one or more processing circuits include at least one of (i) a first processing circuit located on the golf vehicle or (ii) a second processing circuit located remote from the golf vehicle.

3. The golf system of claim 1, wherein the alert is generated remote from the golf vehicle.

4. The golf system of claim 1, wherein the golf vehicle is a first golf vehicle, and wherein the alert is generated at a second golf vehicle.

5. The golf system of claim 1, wherein the alert includes a text alert provided to the user of the golf vehicle using the display device.

6. The golf system of claim 1, wherein the alert includes an audio alert provided to the user of the golf vehicle using the speaker.

7. The golf system of claim 1, wherein the alert includes a video alert provided to the user of the golf vehicle using at least one of the display device or the speaker.

8. The golf system of claim 1, wherein the alert is a first alert, and wherein the one or more processing circuits are configured to:
generate a second alert in the first language;
translate the second alert from the first language to the second language; and
provide the second alert in the second language to an external device remote from the golf vehicle.

9. The golf system of claim 8, wherein the second alert is generated at the golf vehicle.

10. The golf system of claim 1, wherein the first language is identified based on a user profile of the user being associated with the golf vehicle.

11. The golf system of claim 10, wherein the user profile of the user is associated with the golf vehicle using a user device remote from the golf vehicle.

12. The golf system of claim 11, wherein at least one of the one or more processing circuits is located on the golf vehicle, and wherein a translation capability associated with the first language and the second language in pre-emptively loaded onto the at least one of the one or more processing circuits prior to the user accessing the golf vehicle.

13. The golf system of claim 1, wherein the first language is identified based on a user input provided to an operator interface of the golf vehicle.

14. The golf system of claim 1, wherein the one or more processing circuits are configured to:
monitor a location of the golf vehicle; and
provide the alert in the first language to the user of the golf vehicle when the location of the golf vehicle indicates that the golf vehicle is within a geofence associated with the alert.

15. The golf system of claim 1, wherein the alert is a first alert, wherein the one or more processing circuits are configured to:
provide a graphical user interface on the display device, the graphical user interface including a button associated with a unique identification corresponding with a second alert in the first language and in the second language, the button including text in the first language; and
transmit, in response a selection of the button, a signal including the unique identification to an external device to provide the second alert at the external device without actively translating the second alert from the first language to the second language.

16. A golf system comprising:
a golf vehicle including an operator interface and a first processing circuit; and
a computing system remote from the golf vehicle, the computing system including a second processing circuit;
wherein:
the second processing circuit is configured to monitor a location of the golf vehicle;
the second processing circuit is configured to generate an alert in a course-selected language based on the location of the golf vehicle indicating the golf vehicle is within a geofence associated with the alert;
the second processing circuit is configured to transmit the alert to the golf vehicle;
at least one of the first processing circuit or the second processing circuit is configured to translate the alert from the course-selected language to a user-selected language associated with the golf vehicle; and
the first processing circuit is configured to control the operator interface to provide the alert to a user of the golf vehicle in the user-selected language.

17. The golf system of claim 16, wherein the user-selected language is identified based on a user profile of the user being associated with the golf vehicle.

18. The golf system of claim 17, wherein the user profile of the user is associated with the golf vehicle using a user device remote from the golf vehicle, wherein a translation capability associated with the user-selected language and the course-selected language in pre-emptively loaded onto the first processing circuit prior to the user accessing the golf vehicle, and wherein the first processing circuit is configured to translate the alert from the course-selected language to the user-selected language.

19. The golf system of claim 17, wherein the second processing circuit is configured to translate the alert from the course-selected language to the user-selected language.

20. A golf system comprising:
one or more processing circuits configured to:
receive a first input identifying a first language for alerts provided at a golf vehicle;
receive a second input identifying a second language different from the first language for alerts provided at an external device remote from the golf vehicle;
generate an alert associated with a unique identification;
transmit a signal including the unique identification; and
provide (i) the alert in the first language to a user of the golf vehicle using at least one of a display device or a speaker of the golf vehicle or (ii) the alert in the second language to a user of the external device using at least one of a display device or a speaker of the external device in response to receiving the signal;
wherein the unique identification corresponds with the alert in the first language and in the second language such that the alert is provided in an identified language without actively translating the alert between the first language and the second language.
